(19) United States
(12) Patent Application Publication
(10) Pub. No.: US 2015/0237101 A1
(43) Pub. Date: Aug. 20, 2015

(54) Control Command Forwarding In Multimedia Applications Network

(71) Applicant: THOMSON LICENSING, Issy de Moulineaux (FR)

(72) Inventors: Ramkumar Perumanam, Carmel, IN (US); Jens Cahnbley, Princeton Junction, NJ (US); Ishan Uday Mandrekar, Monmouth Junction, NJ (US)

(21) Appl. No.: 14/425,170

(22) PCT Filed: Sep. 19, 2012
(86) PCT No.: PCT/US2010/056006

§ 371 Date: Mar. 2, 2015

(51) Int. Cl. H04L 29/06

(52) U.S. Cl. CPC H04L 65/605

(57) ABSTRACT

Command ports are provided for objects within a data stream. The command ports allow control commands to be issued to individual objects in the data stream rather than for the entire stream. This permits the objects to also have internal rules for when the control commands are used internally and/or reported to other objects in the data stream. Overriding commands are also provided to override an object's internal determination of the command.

### BACKGROUND

In most of the commercially available multimedia frameworks, the underlying implementation of a control command forwarding mechanism is often hidden and hence exact details as how it is implemented is not known. In spite of lack of this information, most importantly, with these frameworks the main limitation is the lack of flexibility in limiting the scope of the control command on the desired portion of a data chain as well as lack of ability for an application to customize the behavior or effect of a control command in the data chain. In these frameworks control commands affect the entire chain and applications cannot specify what portions of the data chain should be affected. Also it's not possible for the applications to override and customize the effect of control commands on various points in the data chain depending on the application logic.

### SUMMARY

A method for control command forwarding is proposed for use within a multimedia framework that supports developing multimedia applications using a data pipeline or a chain model. This method is highly flexible in that it is possible to affect the state of portions of a data chain rather than affecting the entire chain. In addition to this, the method allows applications to customize the effect of a command on the data chain as per the application's needs.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an example object chain with audio and video streams.

FIG. 2 shows the effect of issuing a STOP command to the port of each of the leftmost objects of the chain in sequence.

FIG. 3 illustrates the effect of issuing a START command to the port of one of the leftmost objects of the chain when the entire chain is in STOP state.

FIG. 4 is a flow diagram of a method of controlling objects in a data stream.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

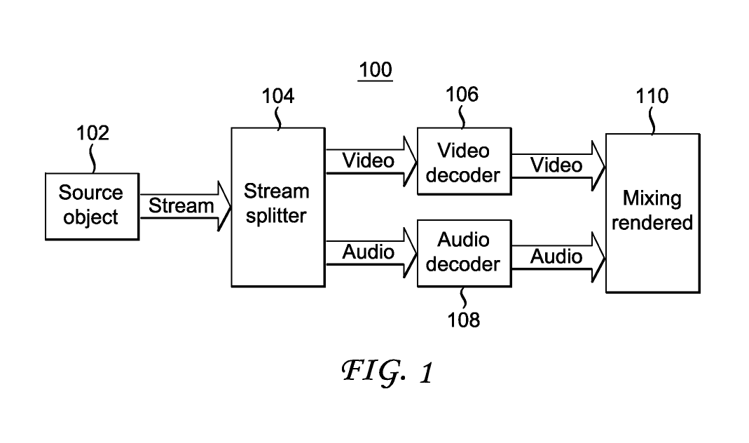

Multimedia framework or middleware is being increasingly used in recent years for developing a variety of audio/video applications for a varied set of target devices. In a typical multimedia application, media data flows in a pipelined fashion through various processing or computing steps or stages that process media data. FIG. 1 shows an example object chain 100 for an audio and video stream. It includes a source object 102 which is split into audio and video components by a stream splitter 104. The split video and audio streams are then fed into a video decoder 106 and an audio decoder 108 respectively. The streams are then rejoined in a mixing renderer 110.

Therefore, most of the multimedia frameworks provide support to implement various processing steps using abstractions such as objects and also provide an ability to interconnect these objects to setup data flows among them in a pipelined fashion. In addition to the ability to setup data flows, it is also desirable for an application to control these data flows. For example, an interactive multimedia player has to start, pause and stop the playback in response to the user commands. This in effect translates to issuing these commands in turn on the underlying data pipeline.

One way to provide this support is to issue these commands individually to each of the objects in the data pipeline which would be quite tedious on a complex data chain. Another approach would be to issue the command on the first object in the data chain which in turn propagates the command to the objects connected to it, and this process is repeated at each of the object that receives the control command. With both of these approaches the control command issued will be applied to the entire data chain. Some applications would like to restrict a control command to affect only a portion of the data chain.

For example, consider an application with a data pipeline consisting of video and audio streams on which audio stream flow should be stopped in response to a user command. In the previous mentioned approaches, it is only possible to stop both the streams and not an individual stream by itself since a control command affects the entire data chain. With a complex object chain, the application would like to reduce the scope of the command to a certain part of the chain and leave the operation of the rest of the chain unaffected. The method disclosed herein addresses the applications' need to control the scope of a control command, and its forwarding behavior. The method implements a set of most common behavior that suits most of the application along with an option to override the behavior to suit the applications' needs.

The flexible and customizable control command forwarding mechanism is implemented by defining an abstraction for connection end points between the objects known as ports that could be distinguished apart from the object abstraction. These connection end points typically accept one type of media stream at any instant. The ports are owned by the object to which they belong, and these ports can be further categorized as input or output ports depending on whether it's used to accept incoming media data or used to send outgoing media data. Before a data flow is setup to the object, these ports remain in an unconnected state, a state in which no media can flow in or out of the object.

To setup a media data flow between the objects, a pair of ports of the related objects is connected. The scope for a control command is implemented by specifying either an object port within the chain or an object on which the command can take into effect. Issuing a control command on a port notifies an object of any changes in one of its connected chains. Objects which receive a command on a port shall execute the command internally and make a decision based on the type of command and the state of the other ports whether to propagate the command further down the data chain. Objects that receive command on itself shall not forward the command on any port. The object shall execute the command internally. In this case, the ports and their states might still remain in its current state.

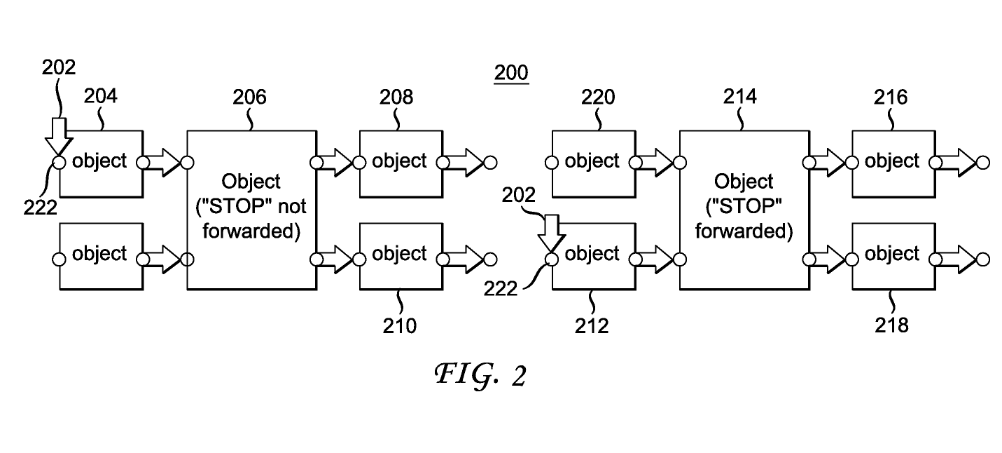

FIG. 2 shows the effect of issuing a STOP command 202 to the port 222 of each of the leftmost objects of a chain 200 in a sequence. A first object 204 is stopped but a second connected object 206 determines that the STOP command is not to be forwarded to the other objects 208, 210 in the stream. The STOP command 202 issued to object 212 is forwarded to connected object 214 which forwards the stop command to downstream objects 216, 218 based, for example, on the fact that object 220 was previously in a stopped state (e.g., both inputs are stopped therefore the stream is stopped altogether).

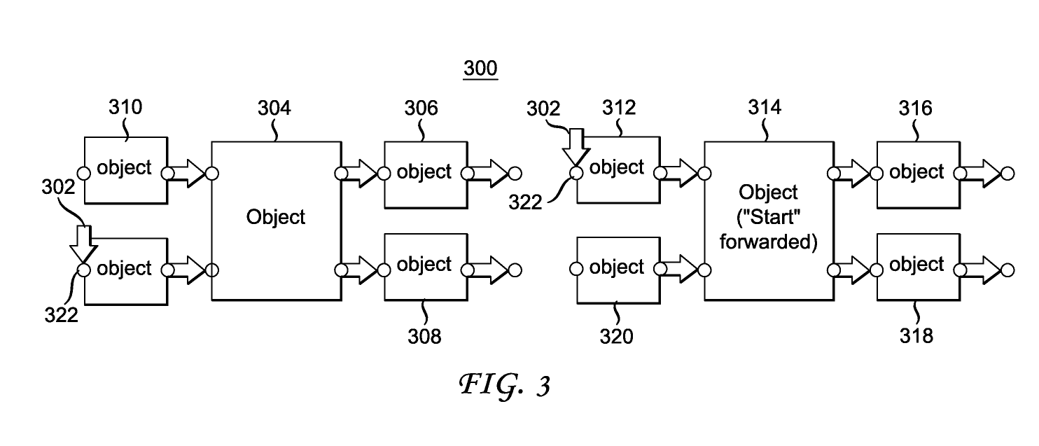

FIG. 3 illustrates the effect of issuing a START command 302 to a port 322 of one of the leftmost objects of a chain 300 when the entire chain is in STOP state. A first object 302 receives the START command and determines, for example, not to start based on the fact that the other chain components 304-310 are in a stopped state. The START command 302 issued to object 312 starts the object and object 314 makes the decision to start and forward the START command to downstream objects 316, 318. In this example, object 320 remains in the stopped state.

A default set of command forwarding decision rules are defined that can be used by an object when a command is received on one of its ports. A few of these commands are illustrated below.
Object with only one input port, which receives the command on that input port shall forward the command to all its output ports.
Object with multiple input ports, which receives the stop command on an input port, shall forward the command to all its output ports, in case all other connected input ports are in the stopped state.
Object with multiple input ports, which receives the start command on an input port, shall forward the command to all its output ports, if all other connected input ports are in stop state.

As mentioned previously, the default set of command forwarding decision rules might not be applicable to certain application scenarios in which case it can be possible to override these rules. This is accomplished by providing programming hooks for an object creator to specify desired command behavior thus allowing the customization of command forwarding method.

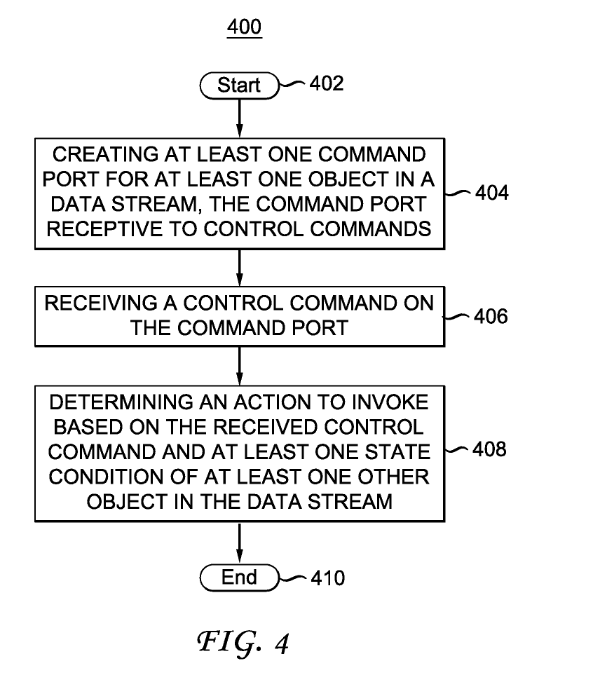

In view of the exemplary systems shown and described above, methodologies that can be implemented in accordance with the embodiments will be better appreciated with reference to the flow charts of FIG. 4. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 4 is a flow diagram of a method 400 of controlling objects in a data stream. The method starts 402 by creating at least one command port for at least one object in a data stream, the command port receptive to control commands 404. The control commands can include at least one of a stop command, a start command and a pause command and the like. A control command is then received on the command port 406. An action to invoke is then determined based on the received control command and at least one state condition of at least one other object in the data stream 408, ending the flow 410. The action can include forwarding the control command to at least one other object when it is determined that at least a portion of the data stream can be processed. The action can also include stopping the control command from being forwarded to other objects when it is determined that no portion of the data stream can be processed. One skilled in the art can also appreciate that other rules can be established for the objects behavior. A priority control command can also be implemented that overrides the internal rules of each of the objects. This can be used to completely stop a data stream and all objects in the stream and the like.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that controls objects in a data stream, comprising:
at least one object of a data stream having at least one command port that receives control commands and applies internal control rules to determine a control action to invoke based on its state and a state of at least one other object.

2. The system of claim 1, wherein the control commands can include at least one of a stop command, a start command and a pause command.

3. The system of claim 1, wherein the object forwards the control command to at least one other object when it is determined that at least a portion of the data stream can be processed.

4. The system of claim 1, wherein the object stops the control command from being forwarded to other objects when it is determined that no portion of the data stream can be processed.

5. The system of claim 1, wherein the object overrides its internal control command rules when a priority command is received.

6. A method for controlling objects in a data stream, comprising:
creating at least one command port for at least one object in a data stream, the command port receptive to control commands;
receiving a control command on the command port; and
determining an action to invoke based on the received control command and at least one state condition of at least one other object in the data stream.

7. The method of claim 6, wherein the control commands can include at least one of a stop command, a start command and a pause command.

8. The method of claim 6 further comprising:
forwarding the control command to at least one other object when it is determined that at least a portion of the data stream can be processed.

9. The method of claim 6 further comprising:
stopping the control command from being forwarded to other objects when it is determined that no portion of the data stream can be processed.

10. The method of claim 6, further comprising:
overriding an object's determination when a priority command is received.

11. A system that controls objects in a data stream, comprising:
a means for creating at least one command port for at least one object in a data stream, the command port receptive to control commands;
a means for receiving a control command on the command port; and
a means for determining an action to invoke based on the received control command and at least one state condition of at least one other object in the data stream.

12. The system of claim 11 further comprising:
a means for at least one of forwarding the control command to at least one other object when it is determined that at least a portion of the data stream can be processed and stopping the control command from being forwarded to other objects when it is determined that no portion of the data stream can be processed.
